(19) United States
(12) Patent Application Publication
(10) Pub. No.: US 2015/0130897 A1
(43) Pub. Date: May 14, 2015

(54) METHOD FOR GENERATING, TRANSPORTING AND RECONSTRUCTING A STEREOSCOPIC VIDEO STREAM

(71) Applicant: S.I.SV.EL SOCIETA' ITALIANA PER LO SVILUPPO DELL'ELETTRONICA S.P.A., None (TO) (IT)

(72) Inventor: Paolo D'Amato Damato, Roma (IT)

(21) Appl. No.: 14/378,546

(22) PCT Filed: Mar. 8, 2013
(86) PCT No.: PCT/IB2013/051865

§ 371 Date: Aug. 13, 2014

(30) Foreign Application Priority Data
Mar. 9, 2012 (IT) TO2012A000208

(51) Int. Cl. H04N 13/00

(52) U.S. Cl. CPC H04N 13/0029; H04N 13/0055; H04N 13/0051
USPC 348/43

(57) ABSTRACT

A method for generating a stereoscopic video stream (84) having composite frames (C), the composite frames including information about a left image (L) and a right image (R) for three-dimensional display of a scene, wherein the pixels of said left image (L) and right image (R) are selected and the selected pixels are entered into the composite frame (C) of the stereoscopic video stream, wherein one of the images (L,R) is captured at a time instant which is delayed with respect to that of the other image (R,L) by a substantially constant and predetermined interval (60).

The present invention relates to a method for generating, transporting and reconstructing a stereoscopic video stream.

For transmission of 3D video signals, so-called “frame-compatible” formats are commonly used. Such formats allow to enter into a Full HD frame, which is used as a container, the two images that make up the stereoscopic pair. In this way, the 3D signal, consisting of two video streams (one for the left eye and one for the right eye) becomes a signal consisting of a single video stream, and therefore can pass through the production and distribution infrastructures used for 2D TV and, most importantly, can be played by 2D and 3D receivers currently available on the market, in particular for High Definition TV.

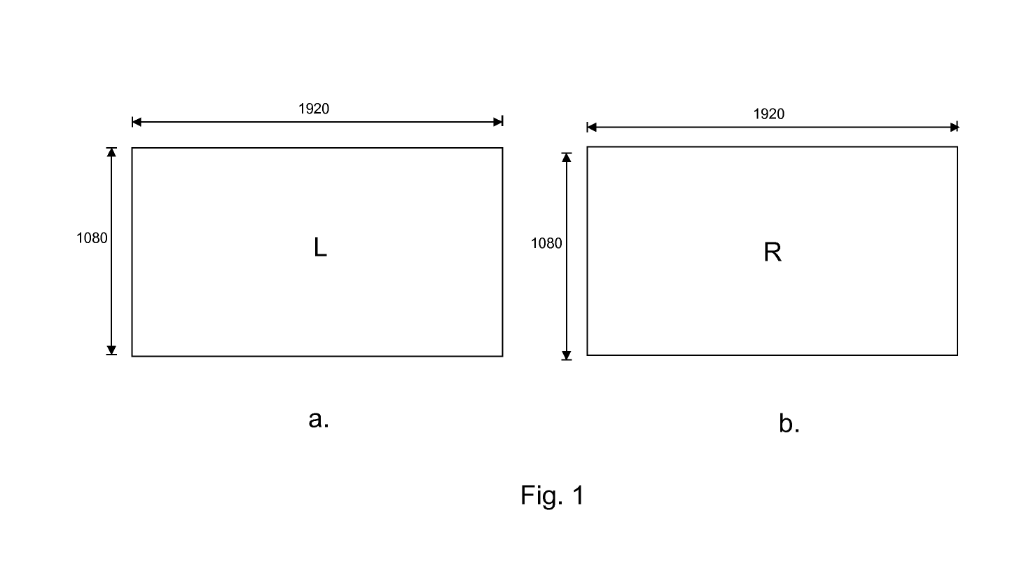

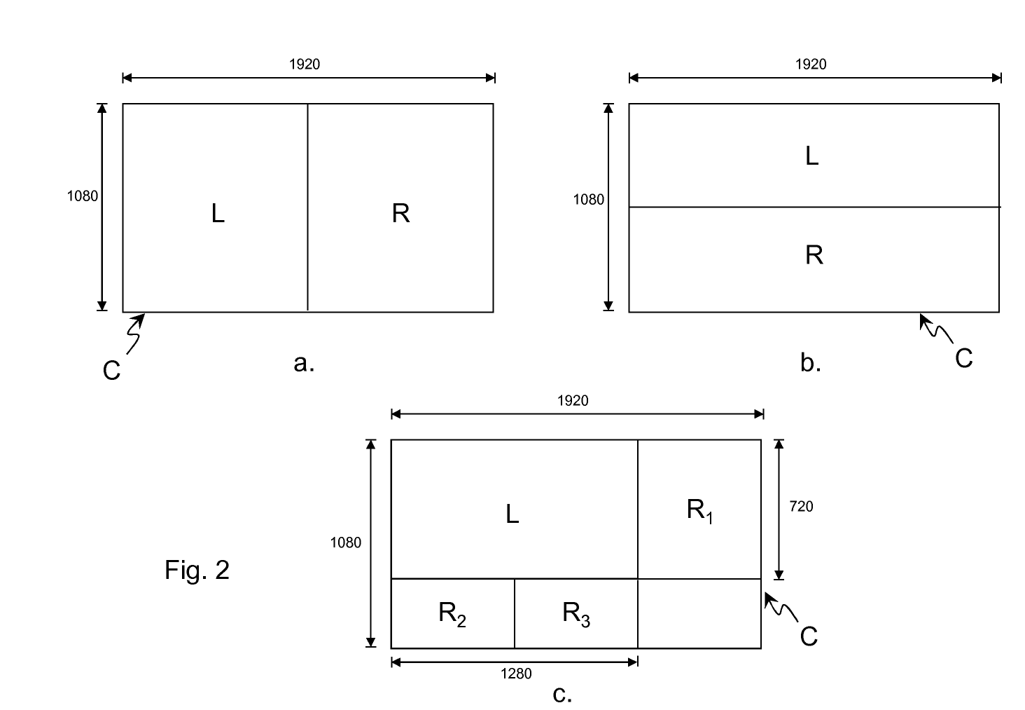

FIGS. 1a and 1b schematically show two HD frames composed of 1920 columns by 1080 rows of pixels (referred to as 1080p), respectively belonging to the video streams for the left eye L and for the right eye R. The two left L and right R images can be entered into a composite frame, by selecting their respective pixels, one next to the other, thus creating the so-called “side-by-side” format, or one on top of the other, thus creating the so-called “top-and-bottom” or “over-under” format (see FIGS. 2a and 2b). Both of these formats have the drawback that they halve the resolution in either one of the two directions, i.e. in the horizontal direction for the side-by-side format or in the vertical direction for the top-and-bottom format.

A third format, called “tile format”, has also been proposed, wherein two 720p images (1280×720 progressive-scan pixels) are entered into a 1080p container frame. According to this format, one of the two images is entered unchanged into the container, while the other one is divided into three parts, which are in turn entered into the space left available by the first image (see FIG. 2c).

These entry operations are carried out at the frame rate frequency of the video stream involved, the typical values of which are approximately 24, 50 or 60 Hz (or fps, frames per second), depending on the adopted standard.

Usually, the stream images are then compressed by using a suitable coding technique and may be subjected to further treatments (multiplexing, channel coding, and the like) in order to be adapted for storage or transmission prior to reproduction.

All these three formats can be used, as aforesaid, for generation and transport (transmission or storage on a physical medium), whereas other formats, not suitable for transport purposes, are used for visualization, namely the so-called “line-alternate” and “frame-alternate” formats.

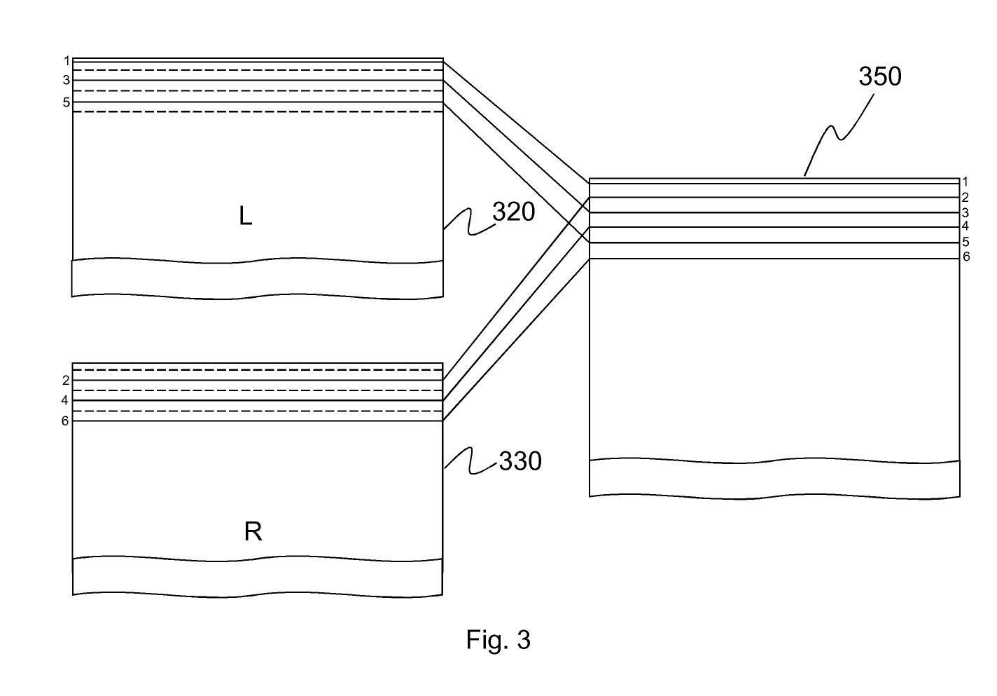

In the “line-alternate” format, the two images L and R are interleaved; for example, with reference to FIG. 3, the image L 320 occupies all the odd rows, while the image R 330 occupies all the even rows of the composite frame 350. This format is used in displays intended for passive glasses, wherein the two lenses are differently polarized. If a line-alternate polarized filter is placed in front of the screen, the left eye will only see the lines corresponding to the image L, and the right eye will only see the lines corresponding to the image R. It is obvious that this halves the vertical resolution of both images, but the human visual system can partly compensate for this loss by putting together into the three-dimensional image the details belonging to the image L and those belonging to the image R.

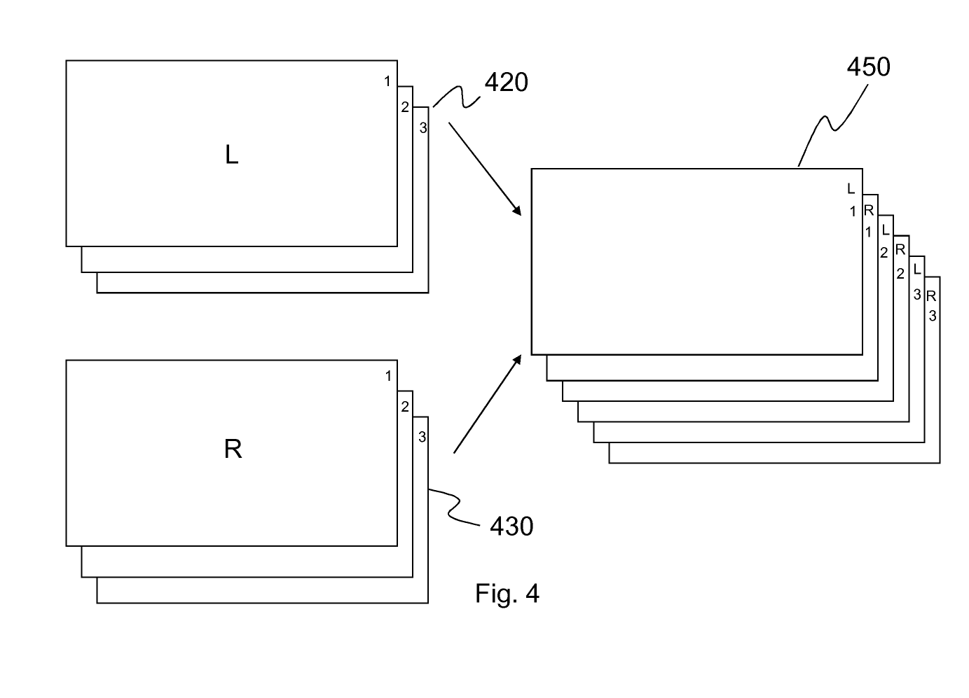

In the “frame-alternate” display system, on the contrary, the image L and the image R are displayed alternatively on the screen (see FIG. 4, where the sequence 450 consists of an alternation of frames L 420 and R 430). In order to make a separation, i.e. to send to each eye the corresponding image, it is necessary to wear shutter glasses, also known as “active” glasses: the shutter alternatively screens one of the two lenses based on a synchronism signal transmitted to the glasses, e.g. via infrared rays, by the television set. The reason why 3D signals are not directly transmitted in the two most common display formats is that such formats do not allow for an effective compression of the video signal, because they destroy the correlation between adjacent rows or consecutive frames. In order to obtain a satisfactory quality, therefore, a much higher bit rate would be required than necessary for transmitting the HD signal used as a container. It follows that transmission formats and display formats are different and are treated as if they were independent of each other.

However, such treatment independency does not allow to optimize the quality of the images. In other words, if the frame-alternate display format is used, the optimal transport format will be different from the one which would be optimal for the line-alternate display format, and vice versa. This fact is generally ignored, with the consequence that either the available band is not fully exploited or alterations are introduced into the stereoscopic image. In other words, the frame-packing formats currently used for transporting video streams are not optimized in view of their visualization on reproduction apparatuses.

For a frame-alternate display, all three of the above-mentioned frame-compatible formats can be used for transporting the video signal, the best one being the tile format because it preserves the balance between horizontal and vertical resolution. However, all three formats suffer from a drawback, i.e. the two images L and R entered into the same composite frame refer to the same time instant (in that the two video cameras are synchronized (“gen-locked”) by the same synchronism signal (“gen-lock”, for generator lock), but are displayed in temporal succession.

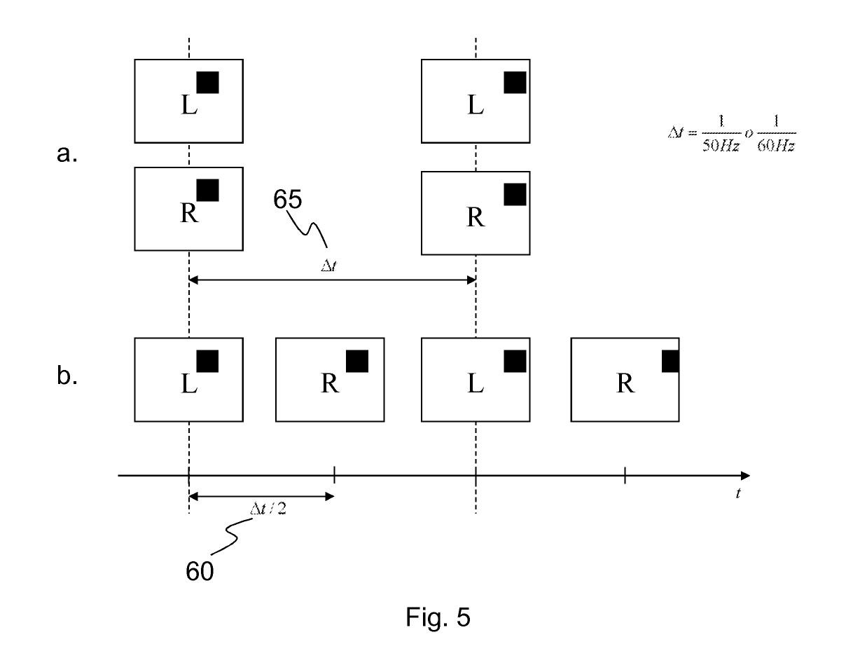

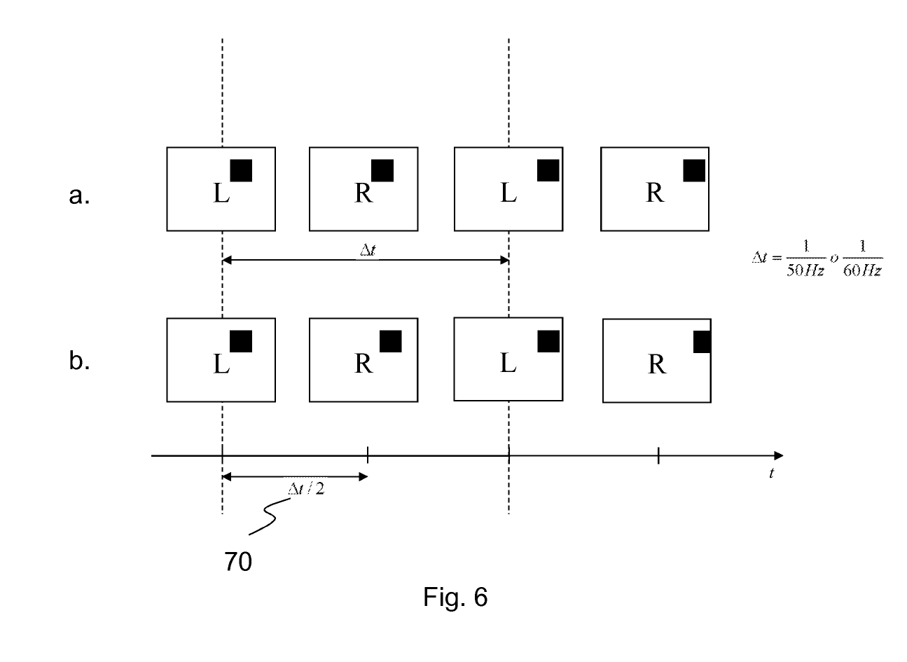

If 1080p video cameras are used, the two images in question are captured simultaneously at preset time intervals Δt, but they are displayed in a delayed and alternated manner at halved intervals Δt/2. If, for example, the television system in use is the 50 Hz European one (one pair of frames L-R every 20 ms), then the display will show a succession of images at 100 Hz (one frame L or R every 10 ms), with L,R,L,R alternation, and so on. FIG. 5a schematically shows how the temporally successive frames L and R comprising a rectangular object moving horizontally relative to the video cameras' viewpoint would be captured according to the prior art. Instead, FIG. 6a shows how the same frames would be displayed on a traditional frame-alternate display. The rectangular object appears to the two eyes in the same position at pairs of different time instants, not in the positions where it should be because of its horizontal movement. An alteration of the temporal succession of the images is created, which the human visual system will translate into depth errors.

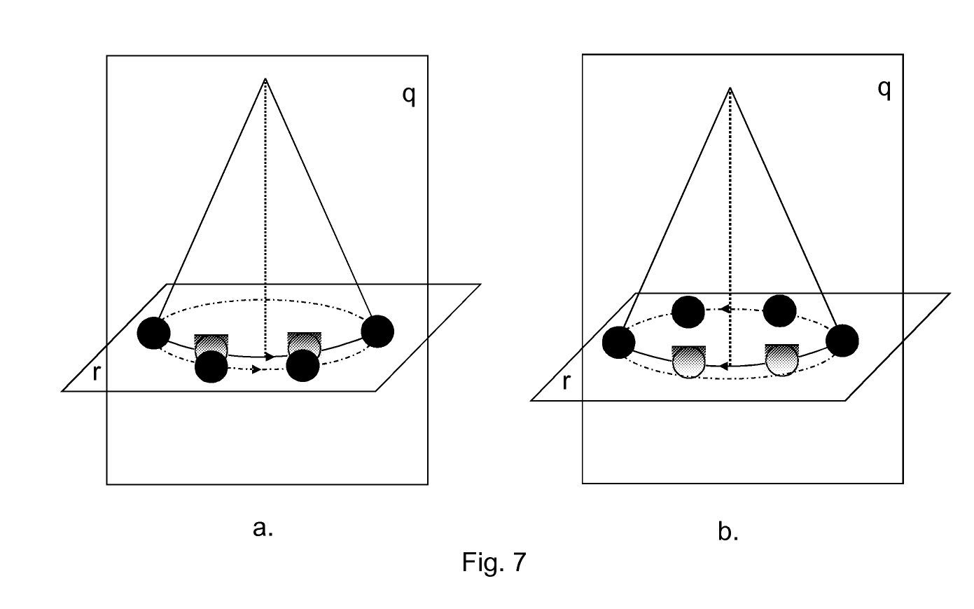

Such errors are similar to those produced by the so-called “Pulfrich effect”, which is visible on test images containing horizontally moving objects, e.g. a pendulum oscillating in a plane perpendicular to the eyes-pendulum conjunction line (see FIG. 7). When a viewer wears special glasses with one partially screened lens, the image of the screened eye will have greater latency than that of the unscreened eye, and therefore the brain will see that image with a certain delay. The human visual system converts this perception delay into a “disparity error” (or depth error), so that the pendulum is perceived by the viewer as moving not in the plane q where it is actually oscillating, but along an elliptical trajectory lying in the plane r perpendicular to q; hence the pendulum, when moving in one direction, will seem to protrude from the screen, and when moving in the other direction will seem to go behind the screen.

The pendulum's apparent direction of rotation depends on which eye is being screened; in the case of FIG. 7 it is assumed that the right eye has been partially screened, which produces an apparent counterclockwise rotation.

The Pulfrich effect is very suggestive, since it causes three-dimensional images to appear on the screen of a normal 2D television set displaying a normal 2D image. This is an optical illusion, which has already been used in order to intentionally create three-dimensional effects, but it is of little use in practice because the three-dimensional effect shows in an uncontrolled manner and only in the presence of objects moving horizontally with respect to the observer.

An object of the present invention is therefore to provide a method for generating, transporting and reconstructing a stereoscopic video stream which, when reproduced on a frame-alternate display, has no depth errors.

In brief, in order to eliminate the above-described optical illusion, it is necessary that the two images L and R entered into the same composite frame be not captured simultaneously, but mutually delayed by half frame (in the case of progressive formats) or by half field (in the case of interleaved formats), i.e. 10 ms when using the 50 Hz European television system, where one frame or one field is captured every 20 ms. This applies to all three frame-compatible formats (e.g.: side-by-side, top-and-bottom, tile format). FIGS. 5b and 6b should be compared with FIGS. 5a and 6a, the latter pair referring to the case wherein the two images are captured simultaneously and are displayed with a delay of half frame or half field.

Of course, if this time shift is made during the capturing stage, the video signal should include a suitable signalling specifying which one of the two views of a stereoscopic pair has been captured first. In fact, if said pairs are displayed in the reverse order with respect to the capturing process, so that, for example, the left images are displayed alternately on the screen after the right ones, but were captured first, the depth error in the viewer's vision will be increased, not removed.

This signalling is particularly simple, since only two possibilities exist: either the left image L is captured first or the right image R is captured first. Therefore, by way of example, this signalling may be assigned just one bit, the value 0 (zero) of which indicates that the former of said cases is true, whereas the value 1 (one) indicates that the latter case is true.

If, however, one also wants to signal the case wherein the two images are captured simultaneously, i.e. the case wherein the present invention is not used (e.g. because a line-alternate display is used), it is clear that the signalling must comprise at least two bits, one of which may indicate, for example, the contemporaneousness or non-contemporaneousness of the two images, and the other bit may indicate which one of the two images precedes the other image. The first bit may be used by the receiver to understand if the signal being transmitted is optimized for the type of display in use: it should be reminded that the transmission of images not captured simultaneously is optimal for frame-alternate displays, while the transmission of images captured simultaneously is optimal for line-alternate displays. In the event of non-optimal transmission, the receiver can take different actions: for example, it may notify the user, by means of a message displayed on the screen, about the probable presence of depth errors and/or it may suggest the user to select the 2D mode, or it may even automatically switch to 2D mode. Another possibility for the receiver is to try and correct the depth errors by locally processing the received images L and R: however, such processing is quite burdensome in computational terms, and the correction obtained will never be perfect.

Further features and objects of the invention are set out in the appended claims, which are intended to be an integral part of the present description, the teachings of which will become more apparent from the following detailed description of a preferred but non-limiting example of embodiment thereof with reference to the annexed drawings, wherein:

FIG. 1 shows two HD frames in 1080p format respectively belonging to a video stream for a left eye and to a video stream for a right eye of a stereoscopic video stream;

FIGS. 2a, 2b and 2c show a pair of stereoscopic images in the side-by-side, over-under and tile formats, respectively;

FIGS. 3 and 4 show a display format of a stereoscopic video stream of the line-alternate and frame-alternate type, respectively;

FIGS. 5a and 6a schematically show a method according to the prior art for capturing and displaying temporally successive left and right frames comprising a rectangular object moving horizontally relative to the viewpoint of video cameras shooting it;

FIGS. 5b and 6b schematically show a method according to the invention for capturing and displaying the temporally successive left and right frames of FIGS. 5a and 5b;

FIG. 7 shows a schematization of the Pulfrich effect;

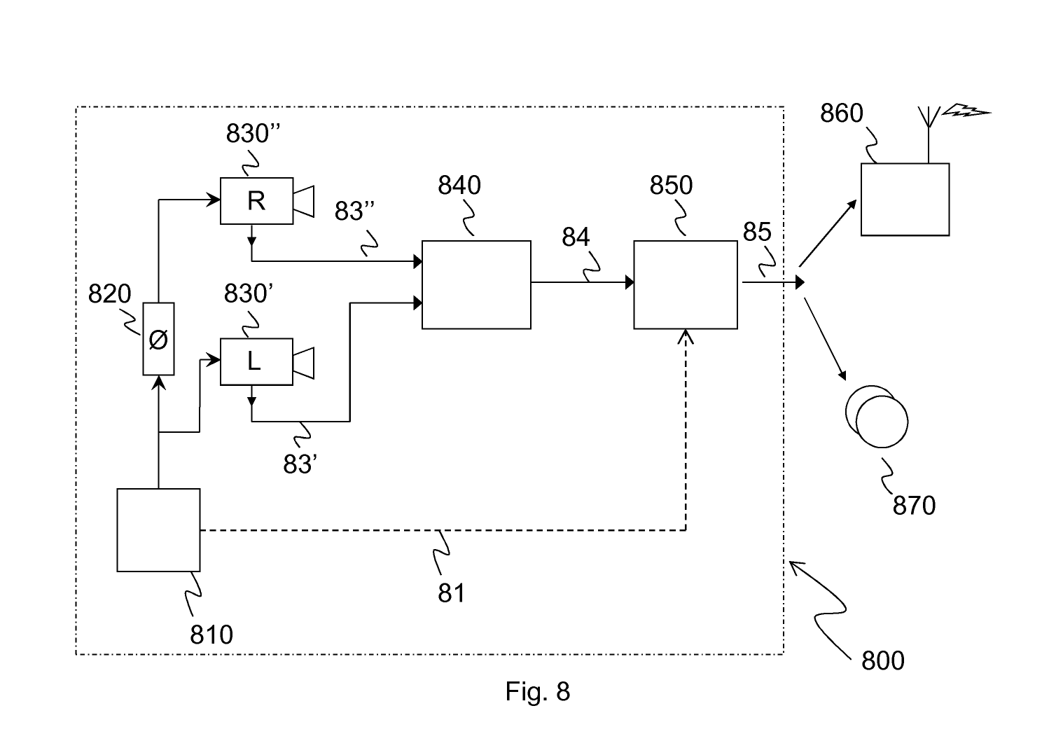

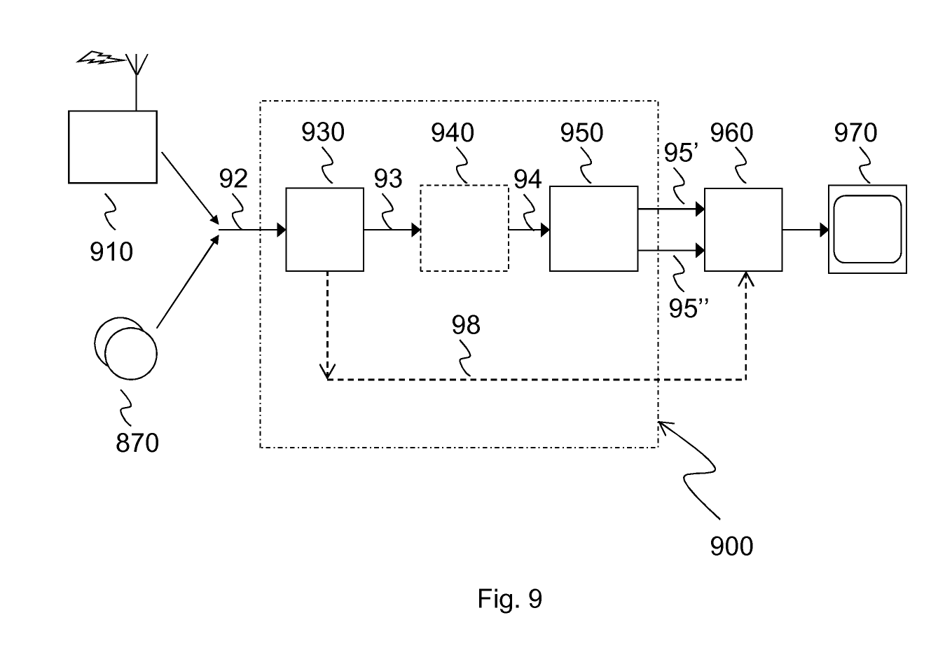

FIGS. 8 and 9 respectively show a production system and a processing system for stereoscopic video streams according to the invention.

FIG. 8 shows one possible system 800 for producing stereoscopic video streams according to the invention, made up of interconnected discrete components, for example, in a television production studio or on a cinematographic set. A pair of 2D video cameras 830′ and 830″ is shooting the scene from two different viewpoints, similarly to what happens in the human visual system. A first video camera 830′ is capturing the scene corresponding to the left eye L, while a second video camera 830″ is capturing the scene corresponding to the right eye R.

A genlock apparatus for generating the capture synchronism 810 generates a common synchronization signal for both video cameras in order to dictate the times of video image capture, which in the European video system takes typically place at a frequency 1/Δt of 50 Hz, i.e. one image every 20 ms, equal to the interval Δt elapsing between the capture of two stereoscopic images belonging to successive pairs L-R. One of these two genlock signals, e.g. the one supplied to the second video camera 830″, is delayed by a time interval substantially equal to Δt/2, i.e. 10 ms for the 50 Hz video standard, by a delaying device 820 interposed between the genlock apparatus 810 and the second video camera 830″. If the delaying device 820 is of the multistandard type, i.e. capable of operating with both the 50 Hz European standard and the 60 Hz US standard, it can be provided that said time interval is adjustable or programmable via suitable adjusting or programming means.

As a consequence, the left images L are captured with the same frequency 1/Δt (typically 50 or 60 Hz) as the right ones, but anticipated by Δt/2 with respect to the images R of the same stereoscopic pair (see FIG. 5b). The delay introduced by the delaying device 820 is preferably equal, save for any undesired uncertainty due to non-removable physical phenomena intrinsic of the electronic components, to half the reciprocal of the video cameras' capture frequency, so as to ensure uniformity of the time intervals elapsing between the capture of the image for one eye and the next capture of the image for the other eye; such uniformity translates into a smoother and more realistic perception of the movements in the scene being framed by the video cameras 830′ and 830″.

The present invention is applicable without distinction to any type of video camera. In particular, it can operate with different video resolutions, e.g. the Full HD resolution, i.e. 1920×1080 pixels (abbreviated as 1080) or 1280×720 pixels (abbreviated as 720). Furthermore, it can output a progressive (p) or interleaved (i) video signal, at 50 or 60 Hz or fps. In particular, it is applicable, for example, to a pair of 2D video cameras capable of capturing a video stream in at least one of the following modes: 1080p@50 Hz, 1080p@60 Hz, 720p@50 Hz, 720p@60 Hz, 1080i@50 Hz and 1080i@60 Hz. Other high-end formats used for cinematographic shooting and projection utilize 24 images per second.

In the case of interleaved 1080i formats, the video cameras 830′ and 830″ output video streams consisting of an alternation of odd and even half-frames of 1920×540 pixels, respectively constituted by 540 odd rows and 540 even rows of the same Full HD 1080p frame. The two lines 83′ and 83″, therefore, carry the time-alternate odd and even half-frames of, respectively, the views L and R belonging to one stereoscopic pair, wherein the capturing of one of the two views is delayed in time.

When the invention is applied to a TV production studio, the video cameras 830′ and 830″ output two video signals formatted in accordance with one of the standard of the SDI (Serial Digital Interface) family, regulated by the SMPTE (Society of Motion Picture and Television Engineers).

The images generated by the video cameras 830′ and 830″ are then packed by a frame packer 840 into one of the above-mentioned formats, i.e. side-by-side, top-and-bottom or tile. The stereoscopic video stream thus obtained is compressed by an encoder 850, which may possibly also add the signalling, on the basis of information coming, for example, from the genlock apparatus 810 (see the dashed connection 81 in FIG. 8), which indicates which one of the two images in the composite frame has been captured first. As an alternative, the signalling may be entered by one of the video cameras 830′ or 830″ into a data field of the video stream 83′ or 83″, e.g. a data field of the SDI stream. In another embodiment, it may be entered by the packer 840 or, alternatively, by a suitable signalling entering unit not shown in FIG. 8. In this case, the encoder 850 can read the signalling contained in the incoming video stream 84 and, depending on the specific implementation, it may either leave it unchanged where it is or appropriately re-enter it in compliance with the compression standard governing it. In the case of the MPEG AVC compression standard, also referred to as ITU-T H.264, the signalling in question may advantageously be included in the so-called SEI (Supplemental Enhancement Information), which is already enabled to transport information about the frame-packing format used when generating the frame-compatible stereoscopic video stream.

FIG. 8 is a merely exemplificative representation of a system for producing a stereoscopic stream according to the invention: it highlights the different functional blocks that execute one or more operations of the system. Actually some or even all functional blocks can be consolidated into a single apparatus executing the operations described for each block in the diagram.

Capturing devices already exist, whether of the consumer or professional type, which incorporate into a single container both video cameras required for stereoscopic shooting. In this case, also the delaying device of the genlock apparatus 810 may advantageously be incorporated into the capturing device.

As aforesaid, the present invention is suitable for use in combination with display devices operating with the so-called frame-alternate technique, wherein the left and right images of each stereoscopic pair are displayed alternately in time on the screen. If the display device operates with the line-alternate technique, the present invention will not be applied.

The signalling entered into the video stream being transmitted, indicating which one of the two images contained in a given composite frame is delayed with respect to the other, must be used by the display device in order to reconstruct the correct frame-alternate sequence. In fact, if the sequence is reconstructed incorrectly, i.e. the image displayed first is the one that was delayed when capturing took place, then the depth error will be increased, not removed.

FIG. 9 illustrates one possible embodiment of a video processing system 900 according to the invention. It may in general be included in a video reception and/or reproduction system optionally comprising other operating units, also at least partially shown in FIG. 9, such as a video processor 960 and a screen 970.

The reproduction and/or reception system may comprise, for example, a television tuner 910 (DVB-T/T2, DVB-S/S2 or DVB-C/C2, ATSC, and the like) enabled to tune to a television signal comprising a stereoscopic video stream generated by a stereoscopic stream generation system according to the invention (e.g. it may be a system like the one shown in FIG. 8), which video stream has subsequently been suitably processed (e.g. via channel coding, multiplexing and the like) to be remotely transmitted over any telecommunication channel, e.g. broadcast by means of a radio transmission unit 860 (FIG. 8). In this case, the tuner 910 carries out operations which are the inverse of those carried out by the unit 860 in order to obtain an output video stream 92, which is very similar to the one inputted to the unit 860, the only difference consisting of undesired alterations due to reception errors, interference and/or noise.

As an alternative or in addition, the video stream 92 may come from a reading unit (not shown in FIG. 9) adapted to read any storage medium 870 (hard disk, DVD, Blu-ray disk, semiconductor-type flash memory and the like), which can read a video stream previously stored on such medium by, for example, a storing or recording unit included in a stereoscopic video stream generating unit according to FIG. 8.

The video stream with delayed stereoscopic capture 92 is sent to a decoder 930, e.g. of the MPEG4-AVC (H.264) type, which carries out the decompression operation inverse to that carried out at the production stage by the encoder 850. It also reads the signalling entered by the encoder 850, indicating which one of the images L and R contained in a composite frame C was captured before the other.

The decoder video stream 93 may then be subjected to an interleaving operation, if the input video stream comes from capturing systems operating with the interleaved capturing system. This operation can be carried out by a suitable unit 940, which receives the interleaved decoded stream 93 and produces a progressive video stream 94 with delayed stereoscopic capture. If the stream images come from progressive capturing systems, then the de-interleaving operation is not necessary and the decoded stream 93, which is already in progressive form, can be directly supplied to the unpacking unit 950, which carries out the operation inverse to that carried out by the packing unit 840.

The decoded progressive stereoscopic video stream 93 or, respectively, 94 is then broken up into two single-image video streams 95′ L and 95″ R, by extracting the left images L and the right images R from each composite frame C. The two video streams for the left eye and for the right eye must not necessarily be supplied to the next stage 960 over two separate connection lines in the form of distinct video streams, as shown by way of example in FIG. 9, since they can also be transmitted in a single multiplexed stream 95 (not shown in FIG. 9) comprising both component streams in any format that can be discerned and processed by the next stage.

The next stage 960 comprises a video processor enabled to create the frame-alternate sequence with the two right and left images in the correct order, which can be deduced from the signalling received by the decoder 930, which must in some way be transmitted to the device 960. By way of example, FIG. 9 shows a communication line 98 over which said capture order signalling is transmitted by the decoder 930 to the video processor 960.

As an alternative to the layout shown in FIG. 9, the reproduction and reception system 900 may include a microprocessor unit (not shown), which coordinates and controls the operations of the system 900, while also acting as a central unit to collect the signallings and all control signals. In this embodiment of the invention, the microprocessor unit receives from the decoder 930 the signalling indicating the capture order, and instructs the video processor 960 to display the video stream on the screen, alternating the images L and R in the proper order, by sending thereto appropriate control signals over a data connection line.

It should be noted that the video processing system 900 may be incorporated, for example, into a television signal receiver, whether or not equipped with a built-in screen 970; therefore it may be used, for example, within a set-top box or a television set.

Likewise, the system 900 may be incorporated into any multimedia reproduction apparatus capable of displaying three-dimensional video contents, such as, for example, a DVD or Blu-ray disk reader, a tablet, etc., whether or not equipped with a built-in screen for image display.

It must be pointed out that the present invention can also be used for generating and reproducing virtual images with the help of software and hardware means capable of entirely simulating the live capture of three-dimensional stereoscopic scenes (computer graphics). Virtual capture is commonly used for making animation videos and films, where the three-dimensional effect is based on the same general principle of shooting one scene from two points of view, so as to simulate the human visual system.

It can therefore be easily understood that what has been described herein may be subject to many modifications, improvements or replacements of equivalent parts and elements without departing from the novelty spirit of the inventive idea, as clearly specified in the following claims.

1. A method for generating a stereoscopic video stream comprising composite frames, said composite frames comprising pixel information about a left image and a right image for three-dimensional display of a scene, wherein said pixels of said left image and right image are selected and said selected pixels are entered into the composite frame of said stereoscopic video stream, wherein one of said images comprised in said composite frame is captured at a time instant which is delayed with respect to that of the other image by a substantially constant and predetermined interval.

2. A method according to claim 1, wherein said interval is adjustable or programmable.

3. A method according to claim 1, wherein it is possible to make said interval substantially equal to half the elapsing between the capturing of two successive left images or right images.

4. A method according to claim 1, wherein a first signalling datum is entered into the stereoscopic video stream to indicate which one of said two images comprised in said composite frame has been captured at a time instant delayed with respect to that of the other image.

5. A method according to claim 1, wherein a second signalling datum is entered into the stereoscopic video stream to indicate contemporaneousness or non-contemporaneousness of the capturing of said images.

6. A device for generating a stereoscopic video stream comprising composite frames, said composite frames comprising pixel information about a left image and a right image for three-dimensional display of a scene, comprising means for selecting said pixels of said left image and right image and for entering said selected pixels into the composite frame of said stereoscopic video stream, said device comprising means for causing one of said images to be captured at a time instant which is delayed with respect to that of the other image by a substantially constant and predetermined interval.

7. A device according to claim 6, wherein means are provided for adjusting or programming said interval.

8. A device according to claim 6, comprising means for making said interval substantially equal to half the time elapsing between the capturing of two successive left images or right images.

9. A device according to claim 6, comprising means for entering a first signalling datum into said stereoscopic video stream to indicate which one of said two images has been captured at a time instant delayed with respect to that of the other image.

10. A device according to claim 6, wherein means are provided for entering a second signalling datum into the video stream to indicate contemporaneousness or non-contemporaneousness of the capturing of said images.

11. A method for reproducing a stereoscopic video stream comprising composite frames, said composite frames comprising pixel information about a left image and a right image for three-dimensional display of a scene, wherein said left image and right image are extracted from one of said composite frames and one of said images is made visible at a time instant which is delayed with respect to that of the other image by a substantially constant and predetermined interval, in the same time order in which said two images were captured.

12. A method according to claim 11, wherein said interval is substantially equal to the interval by which the capturing of said two left and right images was delayed.

13. A method according to claim 11, wherein said interval is substantially equal to half the time elapsing between the capturing of said two successive left images or right images.

14. A method according to claim 11, wherein a first signalling datum is read from said stereoscopic video stream which indicates which one of said two images in said composite frame was captured at a time instant delayed with respect to that of the other image, and wherein said two left and right images are made visible in the same time order in which said two images were captured.

15. A method according to claim 11, wherein a second signalling datum is read from said stereoscopic video stream which indicates contemporaneousness or non-contemporaneousness of the capturing of said images, said second signalling datum being used to determine if said stereoscopic video stream is optimized for a device associated with a display, in particular of the line-alternate or frame-alternate type, that is displaying said stream.

16. A method according to claim 15, wherein, if said second signalling datum indicates that said stereoscopic video stream is not optimized for the type of display, in particular of the line-alternate or frame-alternate type, that is displaying said stream, then said device carries out one or more of the following procedures: it notifies the user about the probable presence of depth or disparity errors due to said non-optimal situation; it suggests to the user to display said stereoscopic video stream in 2D mode and/or automatically switches to 2D mode; it corrects said depth or disparity errors by locally processing said images.

17. A device for reproducing a stereoscopic video stream comprising composite frames, said composite frames comprising pixel information about a left image and a right image for three-dimensional display of a scene, further comprising means for extracting said left image and right image from one of said composite frames and to make visible one of said images at a time instant which is delayed with respect to that of the other image by a substantially constant and predetermined interval, in the same time order in which said two images were captured.

18. A device according to claim 17, comprising means for causing said interval to be substantially equal to an interval by which the capturing of said left and right images was delayed.

19. A device according to claim 17, comprising means for causing said interval to be substantially equal to half the time elapsing between the capturing of two successive left images or right images.

20. A device according to claim 17, comprising means for reading a first signalling datum present in said stereoscopic video stream, indicating which one of said two images was captured at a time instant delayed with respect to that of the other image, and adapted to make visible said left and right images in a time order that depends on said signalling datum being read.

21. A device according to claim 17, comprising means for reading a second signalling datum present in said stereoscopic video stream, indicating contemporaneousness or non-contemporaneousness of the capturing of said images, and means for determining if said stereoscopic video stream is optimized for the type of display, in particular of the line-alternate or frame-alternate type, that is associated with said device and is displaying said stream.

22. A device according to claim 21, wherein, if said second signalling datum indicates that said stereoscopic video stream is not optimized for the type of display, in particular of the line-alternate or frame-alternate type, that is displaying said stream, then said device carries out one or more of the following procedures: it notifies the user about the probable presence of depth or disparity errors; it suggests to the user to display said stereoscopic video stream in 2D mode and/or automatically switches to 2D mode; it corrects the depth or disparity errors by locally processing said images.

23. A stereoscopic video stream comprising composite frames, said composite frames comprising pixel information about a left image and a right image for three-dimensional display of a scene, further comprising a signalling datum indicating which one of said two images has been captured at a time instant delayed with respect to that of the other image.
